(19) United States
(12) Patent Application Publication
(10) Pub. No.: US 2017/0276977 A1
(43) Pub. Date: Sep. 28, 2017

(54) Display Panel and Mobile Terminal Having the Same

(71) Applicant: Guangdong Oppo Mobile Telecommunications Corp., Ltd., Dongguan, Guangdong (CN)

(72) Inventors: Yong Li, Dongguan, Guangdong (CN); Jiao Cheng, Dongguan, Guangdong (CN); Yugui Lin, Dongguan, Guangdong (CN)

(21) Appl. No.: 15/511,165

(22) PCT Filed: Mar. 24, 2016
(86) PCT No.: PCT/CN2016/077204

§ 371 Date: Mar. 14, 2017

(30) Foreign Application Priority Data
May 29, 2015 (CN) 201510290198.6

(51) Int. Cl. G02F 1/135; G06F 1/16; G02F 1/1337; G06F 3/048; G02F 1/1333

(52) U.S. Cl. CPC G02F 1/135; G06F 3/048; G02F 1/1333; G02F 1/1337; G06F 1/1637

(57) ABSTRACT

A display panel and a mobile terminal having the display panel include a transparent region and a border region surrounding the transparent region. The border region includes an inner surface and an outer surface disposed oppositely to the inner surface. The outer surface is an arc-shaped surface extending away from the transparent region and bending. A protection layer is on the inner surface. An orthographic projection of the protection layer is on the arc-shaped surface. Also provided is a mobile terminal having the display panel.

### CROSS-REFERENCE TO RELATED APPLICATION(S)

The present disclosure is a 371 of International Application No. PCT/CN2016/077204, filed Mar. 24, 2016, which claims priority to Chinese Patent Application No. 201510290198.6, filed with the Chinese Patent Office on May 29, 2015 and entitled “DISPLAY PANEL AND MOBILE TERMINAL HAVING THE SAME”, the content of both of which are hereby incorporated by reference in their entireties.

### TECHNICAL FIELD

The present disclosure relates to a display panel and a mobile terminal having the display panel.

### BACKGROUND

With continuous development of technology of manufacturing LCD (Liquid Crystal Display) devices, in order to improve user experience, the borders of the LCD devices are becoming smaller and smaller. In most of mobile terminals available in the market, LCD screens are adopted. In order to increase a size of a display screen of a mobile terminal and improve aesthetic appearance thereof, the border of the display screen of the mobile terminal should be rendered small while the size of the mobile terminal is restricted, and in addition, the edge of the glass panel of the mobile terminal are designed to be arc-shaped to improve the visual effect. However, the arc-shaped surfaces of the edge of the glass panel may cause convex lens effect, such that light and images in the display region at the edge portion of the display screen under the glass may be enlarged and exploded, and a rainbow-colored belt may appear at the edge of the glass panel, resulting in display deformation at the edge of the display region and impacting the overall display effect of the display region.

### SUMMARY

The purpose of the present disclosure is to propose a display panel which can prevent the impact on the display effect of the display screen due to the display deformation at the edge of the display region of the display panel.

The present disclosure further provides a mobile terminal having the display panel.

The present disclosure provides a display panel comprising a transparent region and a border region surrounding the transparent region; the border region comprises an inner surface and an outer surface disposed oppositely to the inner surface; the outer surface is an arc-shaped surface extending away from the transparent region and bending; a protection layer is provided on the inner surface, and an orthographic projection of the protection layer is on the arc-shaped surface.

Furthermore, the protection layer is a frosted layer formed on the inner surface by means of etching.

Furthermore, the protection layer is a transparent frosted film attached to the inner surface, or a semi-transparent ink layer formed by means of screen printing.

Furthermore, the transparent region comprises a back surface and a protection surface disposed oppositely to the back surface, and the back surface is connected with the inner surface and is located in a same plane.

Furthermore, the display panel is a transparent glass plate.

The present disclosure provides a mobile terminal comprising a backlight module, a display module mounted on the backlight module and a display panel mounted on the display module; the display module comprises a display region and a non-display region disposed surrounding the display region; the panel comprises a transparent region and a border region surrounding the transparent region; the border region comprises an inner surface and an outer surface; the outer surface is an arc-shaped surface extending away from the transparent region and bending; a protection layer is provided on the inner surface, and an orthographic projection of the protection layer is on the arc-shaped surface; the display panel covers the display module, with the transparent region covering the display region, the border region covering the non-display region.

Furthermore, the protection layer is a frosted layer formed on the inner surface by means of etching.

Furthermore, the protection layer is a transparent frosted film attached to the inner surface, or a semi-transparent ink layer formed by means of screen printing.

Furthermore, the transparent region comprises a back surface and a protection surface disposed oppositely to the back surface, and the back surface is connected with the inner surface and is located in a same plane.

Furthermore, the display panel is a transparent glass plate.

The protection layer is disposed in the border region of the display panel of the present disclosure, such that the light incident into the border region is scattered when passing through the protection layer, and exits from the arc-shaped outer surface, thereby visually generating atomization effect and preventing the displayed content from being displayed in a deformed manner due to the existence of the arc-shaped outer surface. The user will not see the deformed displayed content and the display effect is ensured.

### BRIEF DESCRIPTION OF THE DRAWINGS

In order to more clearly describe technical solutions according to embodiments of the present disclosure, the accompanying drawings used for describing the embodiments will be briefly introduced hereinafter. Apparently, the accompanying drawings described hereinafter merely show some embodiments of the present disclosure, and persons skilled in the art may also derive other drawings from these accompanying drawings without creative efforts.

FIG. 1 is a schematic cross-sectional view of a display panel according to an embodiment of the present disclosure.

FIG. 2 is a schematic view of a mobile terminal with the display panel as illustrated in FIG. 1, wherein a visible surface is a transparent protection layer of the display panel.

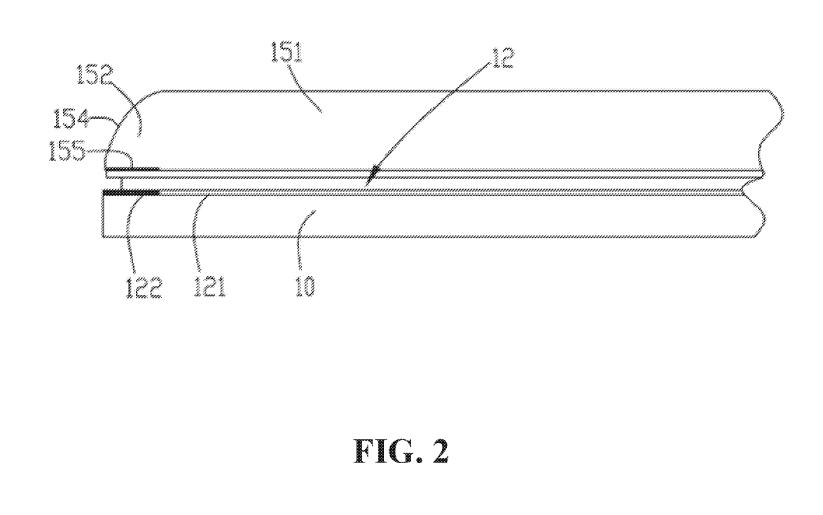

### DETAILED DESCRIPTION

In conjunction with the drawings in the embodiments of the present disclosure, a clear, complete description for the technical solutions in the embodiments of the present disclosure is provided below. Apparently, the described embodiments are a part rather than all of the embodiments of the present disclosure. All other embodiments obtained by persons skilled in the art according to the embodiments of the present disclosure without creative efforts should fall within the protection scope of the present disclosure.

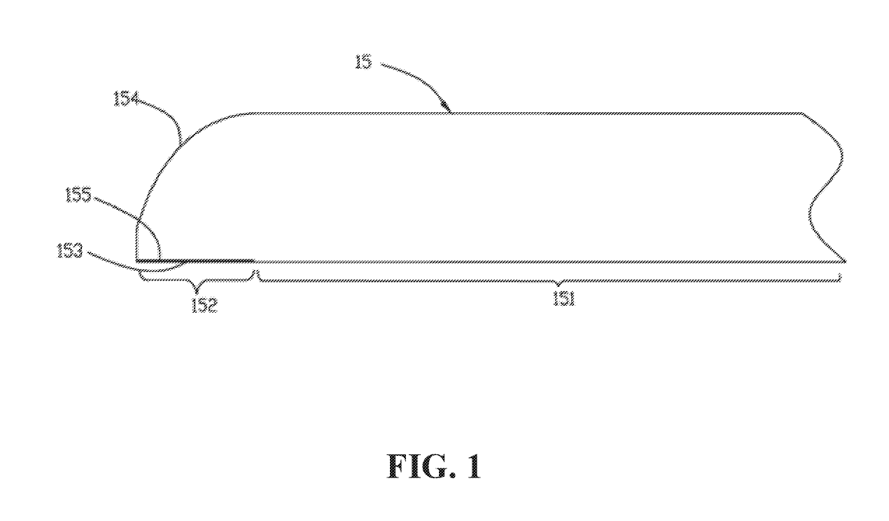

Referring to FIG. 1, a display panel and a mobile terminal is provided in an embodiment of the present disclosure. The mobile terminal includes a backlight module 10, a display module 12 mounted on the backlight module 10 and a display panel 15 mounted on the display module 12. The display module 12 includes a display region 121 and a non-display region 122 disposed surrounding the display region. The display panel 15 includes a transparent region 151 and a border region 152 surrounding the transparent region 151. The border region 152 includes an inner surface 153 and an outer surface 154 disposed oppositely to the inner surface 153. The outer surface 154 is an arc-shaped surface extending away from the transparent region 151 and bending. A protection layer 155 is provided on the inner surface 153. An orthographic projection of the protection layer 155 is on the arc-shaped surface. The display panel 15 covers the display module 12, with the transparent region 151 covering the display region 121, the border region 152 covering the non-display region 122. In the embodiment, the display panel 15 covers the display module 12 of the mobile terminal, protects the display module 12, and operations on the interface of the display module 12 can be performed by touching the display panel 15.

In the embodiment, the arc-shaped outer surface 154 is configured for, when the light emitted from the display region is refracted to the outside of the display panel 15, causing the light exiting from the arc-shaped surface to exit subsequently to the outside of the display panel after the light is refracted due to the arc-shaped surface as viewed from the angle of view of the user, thereby rendering the light emitting region of the display panel larger than the display region 121 of the display module 12, and accordingly visually reducing the width of the non-display region.

In this embodiment, the display panel 15 is a transparent glass plate. The border region 152 and the transparent region 151 integrally form a flat plate. In other embodiments, the border region 152 and the transparent region 151 are disposed to form a certain angle, and constitute a display panel with an outer peripheral side surface. The transparent region 151 includes a back surface and a protection surface disposed oppositely to the back surface. The back surface is connected with the inner surface 153 and is located in a same plane. The outer surface 154 of the border region 152 is a region surrounding the protection surface, that is to say, the outer surface 154 is the outer peripheral region of the display panel 15 which may be a chamfered location or may be the outer peripheral side surface of the display panel 15. The backlight module 10, the display module 12 and the display panel 15 constitute the display screen of the mobile terminal. The transparent region 151 is opposite to the display region 121 of the display module 12. The back surface faces the display module 12, and the protection surface is the outer surface of the display screen of the mobile terminal.

In a first embodiment of the present disclosure, the protection layer 155 is a frosted layer formed on the inner surface 153 by means of etching. That is to say, a uniformly rough frosted layer with particles is formed on the inner surface by etching the whole inner surface 153. The frosted layer is semi-transparent and allows light to pass therethrough. In other embodiments, the protection layer may also be a uniformly rough surface formed by mechanically or manually grinding the inner surface with abrasive materials such as emery, silica sand, garnet powder and so on.

The existence of the arc-shaped surface in the border region of the display panel 15 is such that when images (pictures or characters) are displayed in the display region of the display module 12, the displayed content adjacent to the non-display region is deformed due to expansion of range of the light from the arc-shaped surface, thereby impacting the display effect. However, the protection layer 155 is disposed in the border region 152, such that the light incident into the border region is scattered when passing through the protection layer, and the scattered light exits from the arc-shaped outer surface 154, thereby visually generating atomization effect and preventing the displayed content from being displayed in a deformed manner. The user will not see the deformed displayed content and the display effect is ensured.

In another embodiment of the present disclosure, the protection layer 155 is a transparent frosted film attached to the inner surface 153. The frosted film is a semi-transparent film, one surface being a rough surface, the other surface being provided with adhesive used for attaching the protection layer onto the inner surface 153. When passing through the protection layer in the form of the frosted film, the light incident into the border region is scattered due to the frosted film, and the scattered light exits from the arc-shaped outer surface 154, thereby preventing the displayed content from being displayed in a deformed manner.

In the third embodiment of the present disclosure, the protection layer 155 is a semi-transparent ink layer formed by means of screen printing. In the embodiment, after the display panel 15 is formed, the protection layer 155 is formed from semi-transparent ink on the inner surface 153 by means of screen printing.

The foregoing is merely embodiments of the present disclosure and is not intended to limit the claimed scope of the present disclosure. Persons skilled in the art may understand and realize all or a part of processes of the above-mentioned embodiments, and any equivalent variances made according to the claims of the present disclosure shall fall within the scope of the present disclosure.

1. A display panel, comprising:
a transparent region; and
a border region surrounding the transparent region, wherein
the border region comprises an inner surface and an outer surface disposed oppositely to the inner surface;
the outer surface is an arc-shaped surface extending away from the transparent region and bending; and
a protection layer is provided on the inner surface, and an orthographic projection of the protection layer is on the arc-shaped surface.

2. The display panel of claim 1, wherein the protection layer is a frosted layer formed on the inner surface by means of etching.

3. The display panel of claim 1, wherein the protection layer is a transparent frosted film attached to the inner surface, or a semi-transparent ink layer formed by means of screen printing.

4. The display panel of claim 2, wherein the transparent region comprises a back surface and a protection surface disposed oppositely to the back surface, and the back surface is connected with the inner surface and is located in a same plane.

5. The display panel of claim 1, wherein the display panel is a transparent glass plate.

6. A mobile terminal, comprising:
a backlight module;
a display module mounted on the backlight module; and
a display panel mounted on the display module, the display module comprising a display region and a non-display region disposed surrounding the display region, wherein
the display panel comprises a transparent region and a border region surrounding the transparent region;
the border region comprises an inner surface and an outer surface;
the outer surface is an arc-shaped surface extending away from the transparent region and bending;
a protection layer is provided on the inner surface, and an orthographic projection of the protection layer is on the arc-shaped surface; and
the display panel covers the display module, with the transparent region covering the display region, the border region covering the non-display region.

7. The mobile terminal of claim 6, wherein the protection layer is a frosted layer formed on the inner surface by means of etching.

8. The mobile terminal of claim 6, wherein the protection layer is a transparent frosted film attached to the inner surface, or a semi-transparent ink layer formed by means of screen printing.

9. The mobile terminal of claim 7, wherein the transparent region comprises a back surface and a protection surface disposed oppositely to the back surface, and the back surface is connected with the inner surface and is located in a same plane.

10. The mobile terminal of claim 6, wherein the display panel is a transparent glass plate.

11. The display panel of claim 3, wherein the transparent region comprises a back surface and a protection surface disposed oppositely to the back surface, and the back surface is connected with the inner surface and is located in a same plane.

12. The display panel of claim 11, wherein the display panel is a transparent glass plate.

13. The display panel of claim 2, wherein the display panel is a transparent glass plate.

14. The display panel of claim 3, wherein the display panel is a transparent glass plate.

15. The display panel of claim 4, wherein the display panel is a transparent glass plate.

16. The mobile terminal of claim 8, wherein the transparent region comprises a back surface and a protection surface disposed oppositely to the back surface, and the back surface is connected with the inner surface and is located in a same plane.

17. The mobile terminal of claim 16, wherein the display panel is a transparent glass plate.

18. The mobile terminal of claim 7, wherein the display panel is a transparent glass plate.

19. The mobile terminal of claim 8, wherein the display panel is a transparent glass plate.

20. The mobile terminal of claim 9, wherein the display panel is a transparent glass plate.
